(19) United States
(12) Patent Application Publication
(10) Pub. No.: US 2024/0421926 A1
(43) Pub. Date: Dec. 19, 2024

(54) COMMUNICATION CONTROL METHOD AND COMMUNICATION APPARATUS

(71) Applicant: KYOCERA Corporation, Kyoto (JP)

(72) Inventor: Masato FUJISHIRO, Yokohama-shi (JP)

(73) Assignee: KYOCERA Corporation, Kyoto (JP)

(21) Appl. No.: 18/815,149

(22) Filed: Aug. 26, 2024

Related U.S. Application Data
(63) Continuation of application No. PCT/JP2023/006477, filed on Feb. 22, 2023.

(30) Foreign Application Priority Data
Feb. 28, 2022 (JP) 2022-030321

(51) Int. Cl. H04B 17/391; H04L 5/00

(52) U.S. Cl. CPC H04B 17/391; H04L 5/0051

(57) ABSTRACT

A communication control method performed by a first communication apparatus configured to perform wireless communication with a second communication apparatus in a mobile communication system using a machine learning technology, the communication control method including learning by performing model learning through which a learned model is derived by using learning data including a reception signal from the second communication apparatus, and controlling transmission and/or reception of control data related to the model learning to and from the second communication apparatus.

### RELATED APPLICATIONS

The present application is a continuation based on PCT Application No. PCT/JP2023/006477, filed on Feb. 22, 2023, which claims the benefit of Japanese Patent Application No. 2022-030321 filed on Feb. 28, 2022. The content of which is incorporated by reference herein in their entirety.

### TECHNICAL FIELD

The present disclosure relates to a communication control method and a communication apparatus used in a mobile communication system.

### BACKGROUND

In recent years, in the Third Generation Partnership Project (3GPP), which is a standardization project for mobile communication systems, a study is underway to apply an artificial intelligence (AI) technology, particularly, a machine learning (ML) technology to wireless communication (air interface) in the mobile communication system.

### CITATION LIST

### Non-Patent Literature

Non-Patent Document 1: 3GPP Contribution RP-213599, “New SI: Study on Artificial Intelligence (AI)/Machine Learning (ML) for NR Air Interface”

### SUMMARY

In a first aspect, a communication control method is performed by a first communication apparatus configured to perform wireless communication with a second communication apparatus in a mobile communication system using a machine learning technology. The communication control method includes learning by performing model learning through which a learned model is derived by using learning data including a reception signal from the second communication apparatus, and controlling transmission and/or reception of control data related to the model learning to and from the second communication apparatus.

In a second aspect, a communication apparatus is configured to communicate with another communication apparatus in a mobile communication system using a machine learning technology. The communication apparatus includes a controller configured to perform processing of performing model learning through which a learned model is derived by using learning data including a reception signal from the other communication apparatus, and processing of transmitting and/or receiving control data related to the model learning to and from the other communication apparatus.

### BRIEF DESCRIPTION OF THE DRAWINGS

FIG. 1 is a diagram illustrating a configuration of a mobile communication system according to an embodiment.

FIG. 2 is a diagram illustrating a configuration of a user equipment (UE) according to the embodiment.

FIG. 3 is a diagram illustrating a configuration of a gNB (base station) according to the embodiment.

FIG. 4 is a diagram illustrating a configuration of a protocol stack of a radio interface of a user plane handling data.

FIG. 5 is a diagram illustrating a configuration of a protocol stack of a radio interface of a control plane handling signaling (control signal).

FIG. 6 is a diagram illustrating a functional block configuration of an AI/ML technology in the mobile communication system according to the embodiment.

FIG. 7 is a diagram illustrating an overview of operations according to each embodiment.

FIG. 8 is a diagram illustrating an operation scenario according to a first embodiment.

FIG. 9 is a diagram illustrating a first example of reducing CSI-RSs.

FIG. 10 is a diagram illustrating a second example of reducing the CSI-RSs.

FIG. 11 is an operation flow diagram illustrating a first operation example according to the first embodiment.

FIG. 12 is an operation flow diagram illustrating a second operation example according to the first embodiment.

FIG. 13 is an operation flow diagram illustrating a third operation example according to the first embodiment.

FIG. 14 is an operation flow diagram illustrating a fourth operation example according to the first embodiment.

FIG. 15 is a diagram illustrating an operation scenario according to a second embodiment.

FIG. 16 is an operation flow diagram illustrating an operation example according to the second embodiment.

FIG. 17 is a diagram illustrating an operation scenario according to a third embodiment.

FIG. 18 is an operation flow diagram illustrating an operation example according to the third embodiment.

### DESCRIPTION OF EMBODIMENTS

For applying a machine learning technology to wireless communication in a mobile communication system, a specific technique for applying and controlling the machine learning technology has not yet been established.

In view of this, the present disclosure is to apply a machine learning technology to wireless communication in a mobile communication system.

A mobile communication system according to an embodiment is described with reference to the drawings. In the description of the drawings, the same or similar parts are denoted by the same or similar reference signs.

### (1) First Embodiment

### (1.1) Configuration of Mobile Communication System

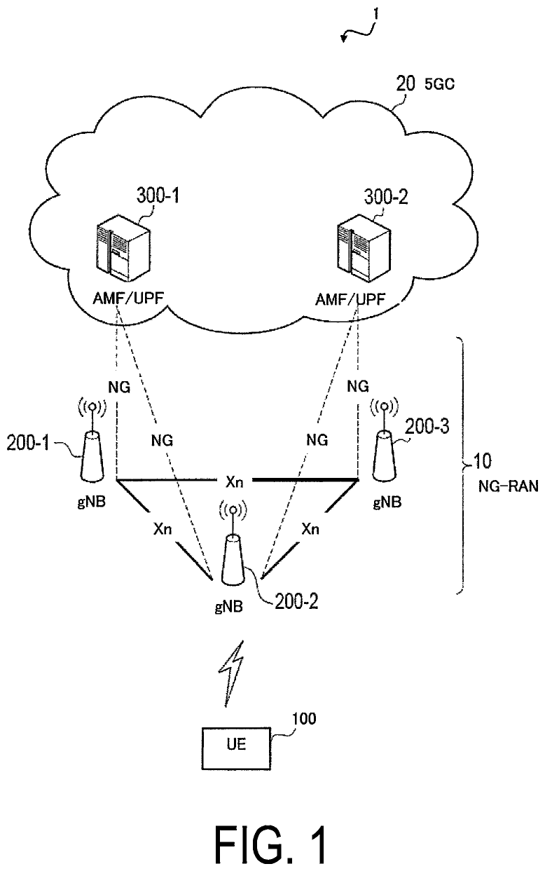

First, a configuration of a mobile communication system according to an embodiment is described. FIG. 1 is a diagram illustrating a configuration of a mobile communication system 1 according to an embodiment. The mobile communication system 1 complies with the 5th Generation System (5GS) of the 3GPP standard. The description below takes the 5GS as an example, but Long Term Evolution (LTE) system may be at least partially applied to the mobile communication system. A sixth generation (6G) system may be at least partially applied to the mobile communication system.

The mobile communication system 1 includes a User Equipment (UE) 100, a 5G radio access network (Next Generation Radio Access Network (NG-RAN)) 10, and a 5G Core Network (5GC) 20. The NG-RAN 10 may be hereinafter simply referred to as a RAN 10. The 5GC 20 may be simply referred to as a core network (CN) 20.

The UE 100 is a mobile wireless communication apparatus. The UE 100 may be any apparatus as long as the UE 100 is used by a user. Examples of the UE 100 include a mobile phone terminal (including a smartphone), a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter simply referred to as one “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

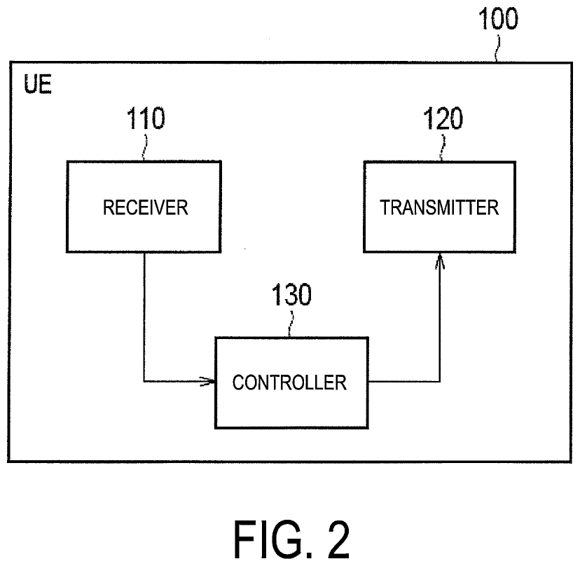

FIG. 2 is a diagram illustrating a configuration of the UE 100 (user equipment) to the embodiment. The UE 100 includes a receiver 110, a transmitter 120, and a controller 130. The receiver 110 and the transmitter 120 constitute a wireless communicator that performs wireless communication with the gNB 200. The UE 100 is an example of the communication apparatus.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control and processing in the UE 100. Such processing includes processing of respective layers to be described later. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

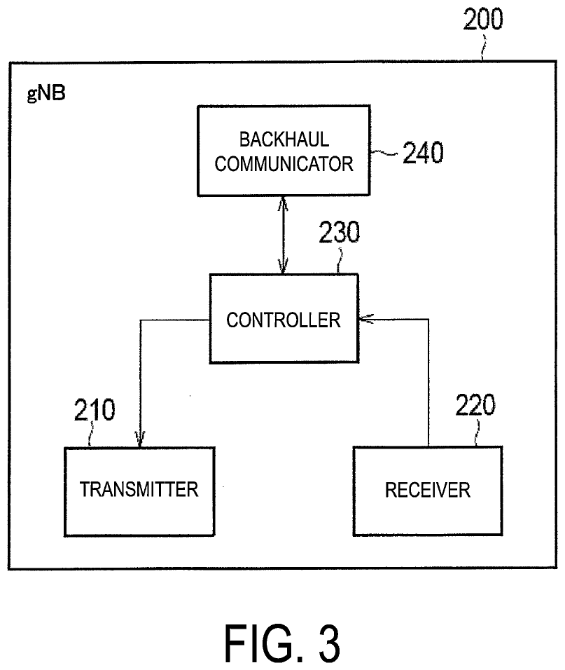

FIG. 3 is a diagram illustrating a configuration of the gNB 200 (base station) according to the embodiment. The gNB 200 includes a transmitter 210, a receiver 220, a controller 230, and a backhaul communicator 240. The transmitter 210 and the receiver 220 constitute a wireless communicator that performs wireless communication with the UE 100. The backhaul communicator 240 constitutes a network communicator that performs communication with the CN 20. The gNB 200 is another example of the communication apparatus.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of control and processing in the gNB 200. Such processing includes processing of respective layers to be described later. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via an Xn interface which is an inter-base station interface. The backhaul communicator 240 is connected to the AMF/UPF 300 via a NG interface between a base station and the core network. Note that the gNB 200 may include a central unit (CU) and a distributed unit (DU) (i.e., functions are divided), and the two units may be connected via an F1 interface, which is a fronthaul interface.

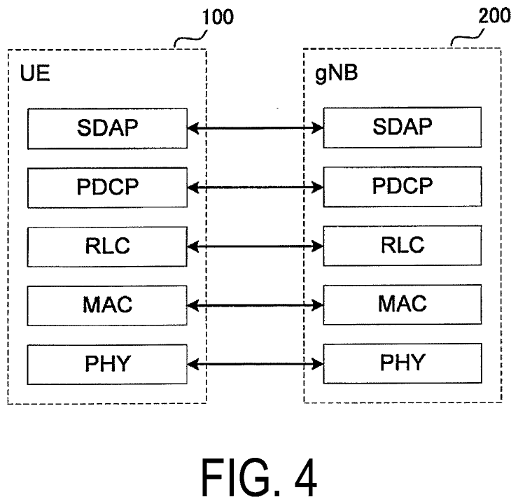

FIG. 4 is a diagram illustrating a configuration of a protocol stack of a radio interface of a user plane handling data.

The protocol of the radio interface of the user plane includes a physical (PHY) layer, a medium access control (MAC) layer, a radio link control (RLC) layer, a packet data convergence protocol (PDCP) layer, and a service data adaptation protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 blind decodes the PDCCH using a radio network temporary identifier (RNTI) and acquires successfully decoded DCI as DCI addressed to the UE 100. The DCI transmitted from the gNB 200 is appended with CRC parity bits scrambled by the RNTI.

In NR, the UE 100 may use a bandwidth that is narrower than a system bandwidth (i.e., a bandwidth of the cell). The gNB 200 configures a bandwidth part (BWP) consisting of consecutive PRBs for the UE 100. The UE 100 transmits and receives data and control signals in an active BWP. For example, up to four BWPs may be configurable for the UE 100. Each BWP may have a different subcarrier spacing. The frequencies of the BWPs may overlap with each other. When a plurality of BWPs are configured for the UE 100, the gNB 200 can designate which BWP to activate by control in the downlink. With this, the gNB 200 dynamically adjusts the UE bandwidth according to an amount of data traffic in the UE 100 or the like, to reduce the UE power consumption.

The gNB 200 can configure, for example, up to three control resource sets (CORESETs) for each of up to four BWPs on the serving cell. The CORESET is a radio resource for control information to be received by the UE 100. Up to 12 or more CORESETs may be configured for the UE 100 on the serving cell. Each CORESET may have an index of 0 to 11 or more. A CORESET may include 6 resource blocks (PRBs) and one, two or three consecutive OFDM symbols in the time domain.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QOS) control performed by a core network and a radio bearer as the unit of QoS control performed by an access layer (Access Stratum (AS)). Note that, when the RAN is connected to the EPC, the SDAP need not be provided.

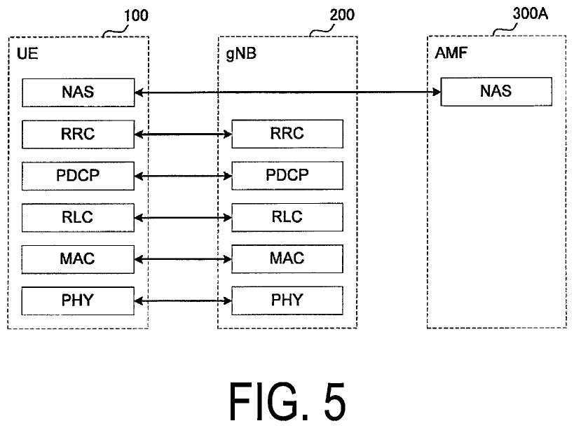

FIG. 5 is a diagram illustrating a configuration of a protocol stack of a radio interface of a control plane handling signaling (a control signal).

The protocol stack of the radio interface of the control plane includes a radio resource control (RRC) layer and a non-access layer (Non-Access Stratum (NAS)) instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS which is positioned upper than the RRC layer performs session management, mobility management, and the like. NAS signaling is transmitted between the NAS of the UE 100 and the NAS of the AMF 300A. Note that the UE 100 includes an application layer other than the protocol of the radio interface. A layer lower than the NAS is referred to as Access Stratum (AS).

### (1.2) AI/ML Technology

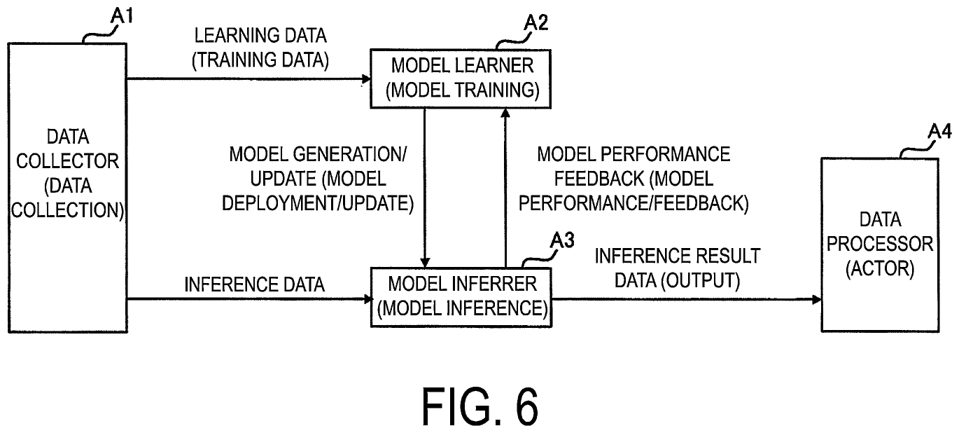

In the embodiment, an AI/ML Technology is described. FIG. 6 is a diagram illustrating a functional block configuration of the AI/ML technology in the mobile communication system 1 according to the embodiment.

The functional block configuration illustrated in FIG. 6 includes a data collector A1, a model learner A2, a model inferrer A3, and a data processor A4.

The data collector A1 collects input data, specifically, learning data and inference data, and outputs the learning data to the model learner A2 and outputs the inference data to the model inferrer A3. The data collector A1 may acquire, as the input data, data in an apparatus provided with the data collector A1 itself. The data collector A1 may acquire, as the input data, data in another apparatus.

The model learner A2 performs model learning. To be specific, the model learner A2 optimizes parameters for the learning model by machine learning using the learning data, derives (generates or updates) a learned model, and outputs the learned model to the model inferrer A3. For example, considering y=ax+b, a (slope) and b (intercept) are the parameters, and optimizing these parameters corresponds to the machine learning. In general, machine learning includes supervised learning, unsupervised learning, and reinforcement learning. The supervised learning is a method of using correct answer data for the learning data. The unsupervised learning is a method of not using correct answer data for the learning data. For example, in the unsupervised learning, feature points are learned from a large amount of learning data, and correct answer determination (range estimation) is performed. The reinforcement learning is a method of assigning a score to an output result and learning a method of maximizing the score.

The model inferrer A3 performs model inference. To be specific, the model inferrer A3 infers an output from the inference data by using the learned model, and outputs inference result data to the data processor A4. For example, considering y=ax+b, x is the inference data and y corresponds to the inference result data. Note that “y=ax+b” is a model. A model in which a slope and an intercept are optimized, for example, “y=5x+3” is a learned model. Here, various approaches for the model are used, such as linear regression analysis, neural network, and decision tree analysis. The above “y=ax+b” can be considered as a kind of the linear regression analysis. The model inferrer A3 may perform model performance feedback to the model learner A2.

The data processor A4 receives the inference result data and performs processing using the inference result data.

When a machine learning technology is applied to wireless communication in a mobile communication system, how to arrange the functional block configuration as illustrated in FIG. 6 is a problem. In the description of each embodiment, wireless communication between the UE 100 and the gNB 200 is mainly assumed. In this case, how to arrange the functional blocks of FIG. 6 in the UE 100 and the gNB 200 is a problem. Also, after the arrangement of each of the functional blocks is determined, how to control and configure each of the functional blocks by the gNB 200 with respect to the UE 100 is a problem.

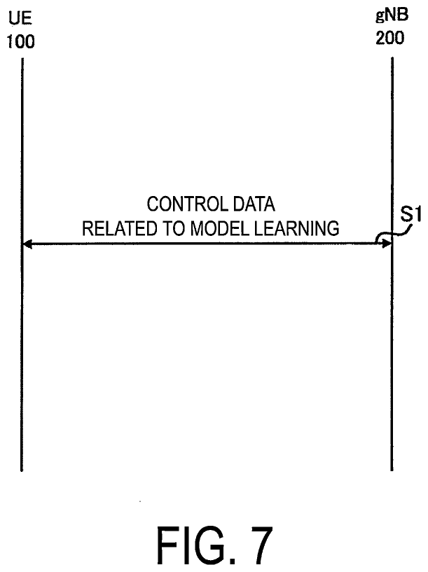

FIG. 7 is a diagram illustrating an overview of operations according to each embodiment. In FIG. 7, one of the UE 100 and the gNB 200 corresponds to a first communication apparatus, and the other corresponds to a second communication apparatus.

In step S1, the UE 100 transmits or receives control data related to the model learning to or from the gNB 200. The control data may be an RRC message that is RRC layer (i.e., layer-3) signaling. The control data may be a MAC Control Element (CE) that is MAC layer (i.e., layer-2) signaling. The control data may be downlink control information (DCI) that is PHY layer (i.e., layer-1) signaling. The downlink signaling may be UE-specific signaling. The downlink signaling may be broadcast signaling. The control data may be a control message in a control layer (e.g., AI/ML layer) dedicated to artificial intelligence or machine learning

### (1.3) Operations According to First Embodiment

Operations according to the first embodiment are described.

### (1.3.1) Operation Scenario

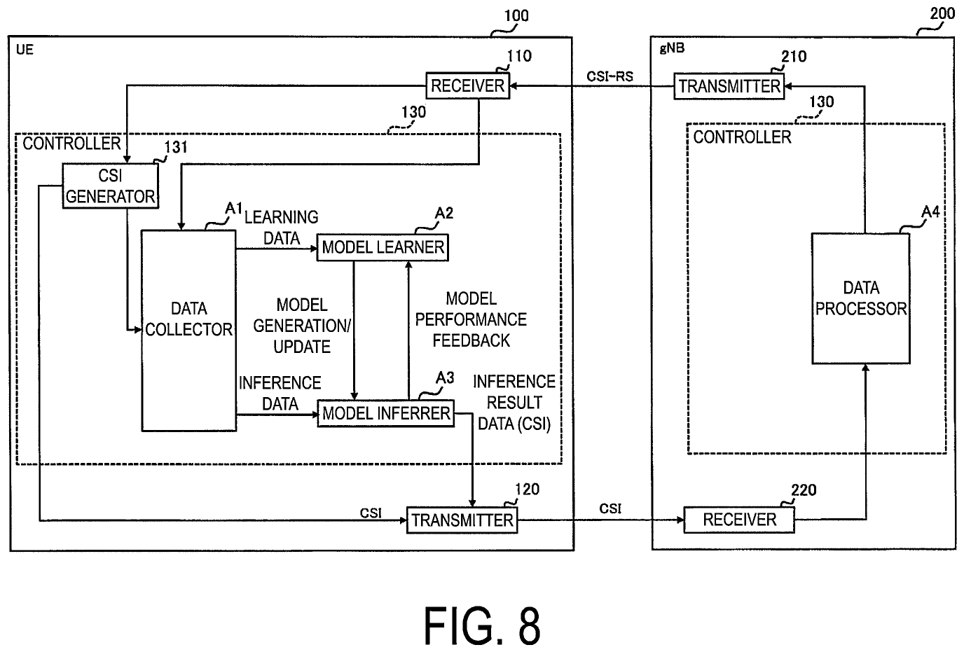

FIG. 8 is a diagram illustrating an operation scenario according to a first embodiment.

In the operation scenario according to the first embodiment, the data collector A1, the model learner A2, and the model inferrer A3 are arranged in the UE 100 (e.g., the controller 130), and the data processor A4 is arranged in the gNB 200 (e.g., the controller 230). In other words, model learning and model inference are performed on the UE 100 side.

In the first embodiment, the machine learning technology is introduced into channel state information (CSI) feedback from the UE 100 to the gNB 200. The CSI transmitted (fed back) from the UE 100 to the gNB 200 is information indicating a downlink channel state between the UE 100 and the gNB 200. The CSI includes at least one selected from the group consisting of a channel quality indicator (CQI), a precoding matrix indicator (PMI), and a rank indicator (RI). The gNB 200 performs, for example, downlink scheduling based on the CSI feedback from the UE 100.

The gNB 200 transmits a reference signal for the UE 100 to estimate a downlink channel state. Such a reference signal may be, for example, a CSI reference signal (CSI-RS). Such a reference signal may also be a demodulation reference signal (DMRS). In the description of the first embodiment, assume that the reference signal is a CSI-RS.

First, in the model learning, the UE 100 (receiver 110) receives a first reference signal from the gNB 200 by using a first resource. Then, the UE 100 (model learner A2) derives a learned model for inferring CSI from the reference signal by using learning data including the first reference signal. In the description of the first embodiment, such a first reference signal may be referred to as a full CSI-RS.

For example, the UE 100 (CSI generator 131) performs channel estimation by using the reception signal (CSI-RS) received by the receiver 110 from the gNB 200, and generates CSI. The UE 100 (transmitter 120) transmits the generated CSI to the gNB 200. The model learner A2 performs model learning by using a plurality of sets of the reception signal (CSI-RS) and the CSI as the learning data to derive a learned model for inferring the CSI from the reception signal (CSI-RS).

Second, in the model inference, the UE 100 (receiver 110) receives a second reference signal from the gNB 200 by using a second resource that is less than the first resource. Then, the UE 100 (model inferrer A3) uses the learned model to infer the CSI as the inference result data from inference data including the second reference signal. In the description of the first embodiment, such a second reference signal may be referred to as a partial CSI-RS or a punctured CSI-RS.

For example, the UE 100 (model inferrer A3) uses the reception signal (CSI-RS) received by the receiver 110 from the gNB 200 as the inference data, and infers the CSI from the reception signal (CSI-RS) by using the learned model. The UE 100 (transmitter 120) transmits the inferred CSI to the gNB 200.

This enables the UE 100 to feed back accurate (complete) CSI to the gNB 200 from a small number of CSI-RSs (partial CSI-RSs) received from the gNB 200. For example, the gNB 200 can reduce (puncture) the CSI-RS when intended for overhead reduction. In addition, the UE 100 can cope with a situation in which a radio situation deteriorates and some CSI-RSs cannot be normally received.

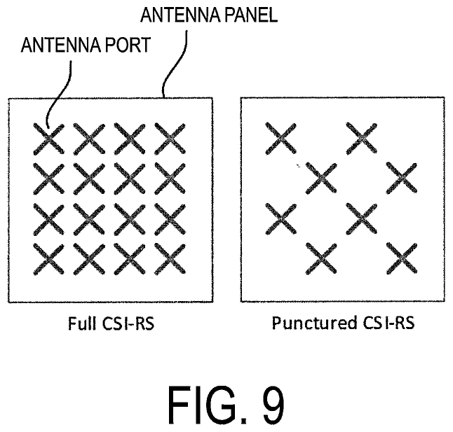

FIG. 9 is a diagram illustrating a first example of reducing the CSI-RSs. In the first example, the gNB 200 reduces the number of antenna ports for transmitting the CSI-RS. For example, the gNB 200 transmits the CSI-RS from all antenna ports of the antenna panel in a mode in which the UE 100 performs the model learning. On the other hand, in the mode in which the UE 100 performs model inference, the gNB 200 reduces the number of antenna ports for transmitting the CSI-RSs, and transmits the CSI-RSs from half the antenna ports of the antenna panel. Note that the antenna port is an example of the resource. This can reduce the overhead, improve a utilization efficiency of the antenna ports, and give an effect of power consumption reduction.

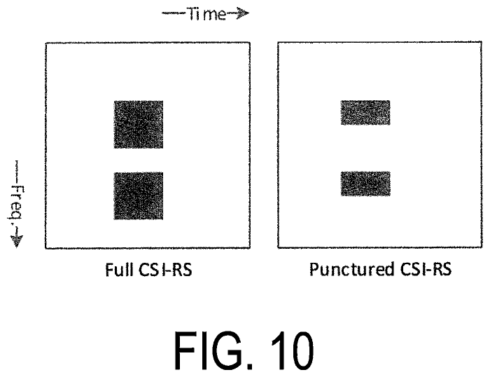

FIG. 10 is a diagram illustrating a second example of reducing the CSI-RSs. In the second example, the gNB 200 reduces the number of radio resources for transmitting the CSI-RSs, specifically, the number of time-frequency resources. For example, the gNB 200 transmits the CSI-RS by using a predetermined time-frequency resource in a mode in which the UE 100 performs the model learning. On the other hand, in a mode in which the UE 100 performs the model inference, the gNB 200 transmits the CSI-RS using a smaller amount of time-frequency resources than predetermined time-frequency resources. This can reduce the overhead, improve a utilization efficiency of the radio resources, and give an effect of power consumption reduction.

### (1.3.2) First Operation Example

In the first embodiment, a first operation example is described.

In the first operation example, the gNB 200 transmits a switching notification as the control data to the UE 100, the switching notification providing notification of mode switching between a mode for performing the model learning (hereinafter, also referred to as a “learning mode”) and a mode for performing model inference (hereinafter, also referred to as an “inference mode”). The UE 100 receives the switching notification and performs the mode switching between the learning mode and the inference mode. This enables the mode switching to be appropriately performed between the learning mode and the inference mode. The switching notification may be configuration information to configure a mode for the UE 100. The switching notification may be also a switching command for indicating to the UE 100 the mode switching.

In the first operation example, when the model learning is completed, the UE 100 transmits a completion notification as the control data to the gNB 200, the completion notification indicating that the model learning is completed. The gNB 200 receives the completion notification. This enables gNB 200 to grasp that the model learning is completed on the UE 100 side.

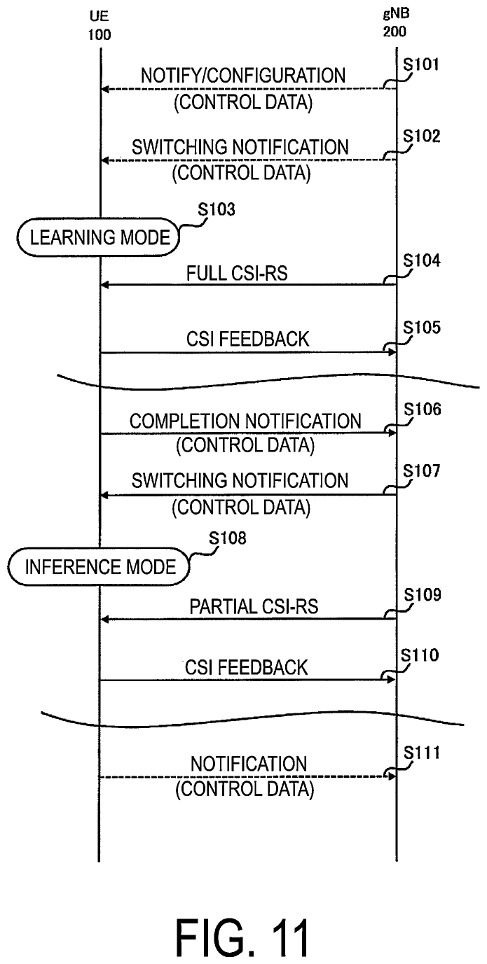

FIG. 11 is an operation flow diagram illustrating the first operation example according to the first embodiment. This flow may be performed after the UE 100 establishes an RRC connection to the cell of the gNB 200. Note that in the operation flow described below, dashed lines indicate steps which may be omitted.

In step S101, the gNB 200 may notify the UE 100 of or configure for the UE, as the control data, an input data pattern in the inference mode, for example, a transmission pattern (puncture pattern) of the CSI-RS in the inference mode. For example, the gNB 200 notifies the UE 100 of the antenna port and/or the time-frequency resource for transmitting or not transmitting the CSI-RS in the inference mode.

In step S102, the gNB 200 may transmit a switching notification for starting the learning mode to the UE 100.

In step S103, the UE 100 starts the learning mode.

In step S104, the gNB 200 transmits a full CSI-RS. The UE 100 receives the full CSI-RS and generates CSI based on the received CSI-RS. In the learning mode, the UE 100 may perform supervised learning using the received CSI-RS and CSI corresponding to the received CSI-RS. The UE 100 may derive and manage a learning result (learned model) per communication environment of the UE 100, for example, per reception quality (RSRP, RSRQ, or SINR) and/or migration speed.

In step S105, the UE 100 transmits (feeds back) the generated CSI to the gNB 200.

Thereafter, in step S106, when the model learning is completed, the UE 100 transmits a completion notification indicating that the model learning is completed to the gNB 200. The UE 100 may transmit the completion notification to the gNB 200 when the derivation (generation or update) of the learned model is completed. Here, the UE 100 may transmit a notification indicating that learning is completed per communication environment (e.g., migration speed and reception quality) of the UE 100 itself. In this case, the UE 100 includes, in the notification, information indicating for which communication environment the completion notification is.

In step S107, the gNB 200 transmits, to the UE 100, a switching information notification for switching from the learning mode to the inference mode.

In step S108, the UE 100 switches from the learning mode to the inference mode in response to receiving the switching notification in step S107.

In step S109, the gNB 200 transmits a partial CSI-RS. Once receiving the partial CSI-RS, the UE 100 uses the learned model to infer CSI from the received CSI-RS. The UE 100 may select a learned model corresponding to the communication environment of the UE 100 itself from among learned models managed per communication environment, and may infer the CSI using the selected learned model.

In step S110, the UE 100 transmits (feeds back) the inferred CSI to the gNB 200.

In step S111, when the UE 100 determines that the model learning is necessary, the UE 100 may transmit a notification as the control data to the gNB 200, the notification indicating that the model learning is necessary. For example, the UE 100 considers that accuracy of the inference result cannot be guaranteed and transmits the notification to the gNB 200 when the UE 100 moves, the migration speed of the UE 100 changes, the reception quality of the UE 100 changes, the cell in which the UE exists changes, or the bandwidth part

(BWP) the UE 100 uses for communication changes.

### (1.3.3) Second Operation Example

A second operation example according to the first embodiment is described. The second operation example may be used together with the above-described operation example.

In the second operation example, the gNB 200 transmits a completion condition notification as the control data to the UE 100, the completion condition notification indicating a completion condition of the model learning. The UE 100 receives the completion condition notification and determines completion of the model learning based on the completion condition notification. This enables the UE 100 to appropriately determine the completion of the model learning. The completion condition notification may be configuration information to configure the completion condition of the model learning for the UE 100. The completion condition notification may be included in the switching notification providing notification of (indicating) switching to the learning mode.

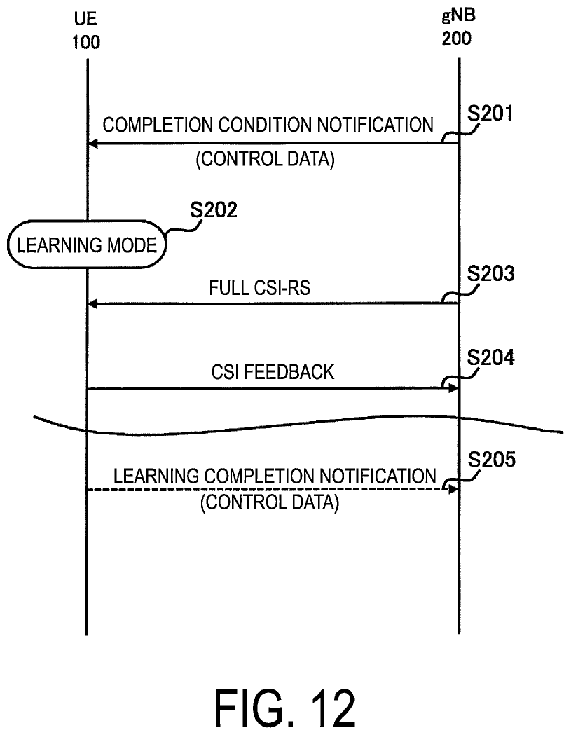

FIG. 12 is an operation flow diagram illustrating the second operation example according to the first embodiment.

In step S201, the gNB 200 transmits the completion condition notification as the control data to the UE 100, the completion condition notification indicating the completion condition of the model learning. The completion condition notification may include at least one selected from the group consisting of the following pieces of completion condition information.
Acceptable error for correct answer data:
   For example, adopted is an acceptable range of an error between the CSI generated by using a normal CSI feedback calculation method and the CSI inferred by the model inference. At a stage where the learning has progressed to some extent, the UE 100 can infer the CSI by using the learned model at that point in time, compare the CSI with the correct CSI, and determine that the learning is completed based on the fact that the error is within the acceptable range.
The number of pieces of learning data: the number of pieces of data used for learning. For example, the number of received CSI-RSs corresponds to the number of pieces of learning data. The UE 100 can determine that the learning is completed based on the fact that the number of received CSI-RSs in the learning mode (step S202) reaches the number of pieces of learning data indicated by a notification (configuration).
The number of learning trials: the number of times the model learning is performed using the learning data. The UE 100 can determine that the learning is completed based on the fact that the number of times of the learning in the learning mode reaches the number of times indicated by a notification (configuration).
Output score threshold: for example, a score in reinforcement learning. The UE 100 can determine that the learning is completed based on the fact that the score reaches the score indicated by a notification (configuration).

The UE 100 continues the learning based on the full CSI-RS until determining that the learning is completed (step S203, step S204).

In step S205, the UE 100, when determining that the model learning is completed, may transmit a completion notification indicating that the model learning is completed to the gNB 200.

### (1.3.4) Third Operation Example

In the first embodiment, a third operation example is described. The third operation example may be used together with the above-described operation examples.

When the accuracy of the CSI feedback is desired to be increased, not only the CSI-RS but also other types of data, for example, reception characteristics of a physical downlink shared channel (PDSCH) can be used as the learning data and the inference data. In the third operation example, the gNB 200 transmits data type information as the control data to the UE 100, the data type information designating at least a type of data used as the learning data. In other words, the gNB 200 designates what is to be the learning data/inference data (type of input data) with respect to the UE 100. The UE 100 receives the data type information and performs the model learning using the data of the designated data type. This enables the UE 100 to perform appropriate model learning.

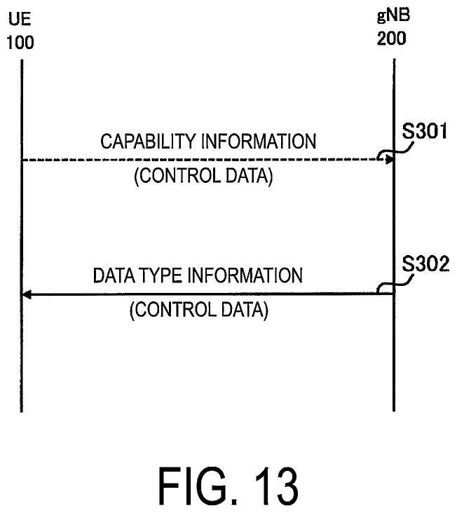

FIG. 13 is an operation flow diagram illustrating the third operation example according to the first embodiment.

In step S301, the UE 100 may transmit capability information as the control data to the gNB 200, the capability information indicating which type of input data the UE 100 can handle in the machine learning. Here, the UE 100 may further transmit a notification indicating additional information such as the accuracy of the input data.

In step S302, the UE 100 transmits the data type information to the gNB 200. The data type information may be configuration information to configure a type of the input data for the UE 100. Here, the type of the input data may be the reception quality and/or UE migration speed for the CSI feedback. The reception quality may be (reference signal received power (RSRP), reference signal received quality (RSRQ), signal-to-interference-plus-noise ratio (SINR), bit error rate (BER), block error rate (BLER), analog-to-digital converter output waveform, or the like.

Note that when UE positioning to be described later is assumed, the type of the input data may be position information (latitude, longitude, and altitude) of Global Navigation Satellite System (GNSS), RF fingerprint (cell ID, reception quality thereof, and the like), angle of arrival (AoA) of reception signal, reception level/reception phase/reception time difference (OTDOA) for each antenna, roundtrip time, and reception information of short-range wireless communication such as a wireless LAN.

Note that the gNB 200 may designate the type of the input data independently for each of the learning data and the inference data. The gNB 200 may designate the type of input independently for each of the CSI feedback and the UE positioning.

### (1.3.5) Fourth Operation Example

In the first embodiment, a fourth operation example is described. The fourth operation example may be used together with the above-described operation examples.

In the fourth operation example, the UE 100 transmits preference information as the control data to the gNB 200, the preference information indicating a preference of the UE 100 for the transmission pattern of the second reference signal (that is, the partial CSI-RS). The gNB 200 receives the preference information and decides the transmission pattern of the partial CSI-RS in consideration of a transmission pattern of the partial CSI-RS (hereinafter also referred to as a “puncture pattern”) desired by the UE 100. This enables the gNB 200 to appropriately decide the transmission pattern of the partial CSI-RS.

Here, depending on the learning model in the UE 100, there may be a region with high accuracy and a region with low accuracy. For example, the punctured CSI-RS may be used in a certain frequency domain with no problem, but the full CSI-RS may be required in another frequency domain. Therefore, by transmitting the preference for the transmission pattern of the partial CSI-RS from the UE 100, resource consumption of the CSI-RS can be efficiently suppressed.

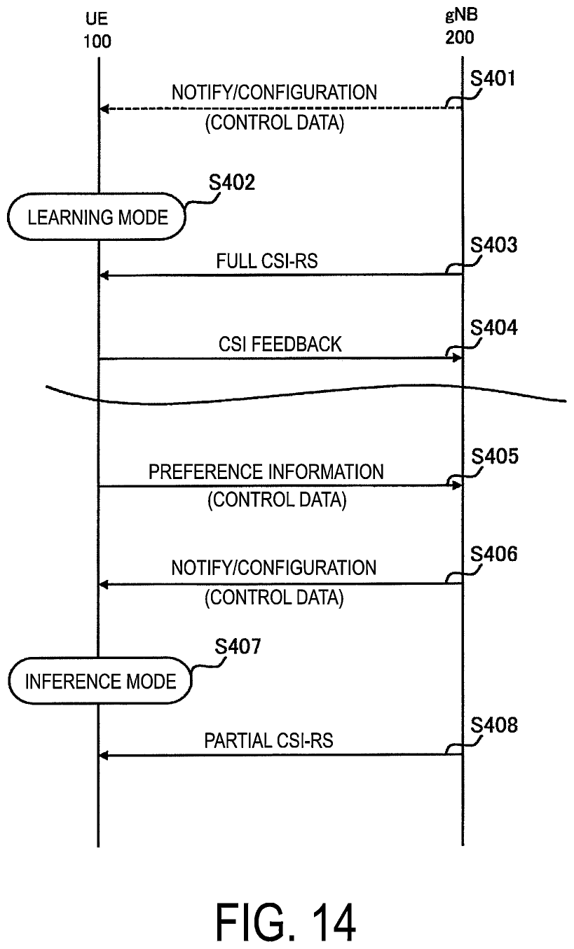

FIG. 14 is an operation flow diagram illustrating the fourth operation example according to the first embodiment.

In step S401, the gNB 200 may notify the UE 100 of the puncture pattern of the CSI-RS as control data.

In step S402, the UE 100 starts the learning mode.

In step S403, the gNB 200 transmits the CSI-RS to the UE 100.

In step S404, the UE 100 transmits CSI based on the full CSI-RS to the gNB 200.

In the learning mode, the UE 100 performs the model learning using the full CSI-RS as the learning data. Here, as a result of the learning, the UE 100 determines a region where the accuracy can be obtained and a region where the accuracy cannot be obtained. The UE 100 may determine whether sufficient accuracy is obtained for each puncture pattern indicated by the notification from the gNB 200 in step S401.

In step S405, the UE 100 transmits the preference information indicating the preference for the partial CSI-RS transmission pattern as the control data to the gNB 200 in accordance with a result of the determination above. The preference information may be information indicating a resource (e.g., a time-frequency domain) in which the full CSI-RS is not required. The preference information may be information indicating a resource (e.g., a time-frequency domain) in which the full CSI-RS is required.

The preference information elements may include at least one selected from the group consisting of the following pieces of information.
Information indicating the time-frequency domain: for example, frequency (such as a range of resource blocks) and/or time (such as a slot and a subframe).
Information indicating the CSI-RS transmission pattern: information designating the puncture pattern may be used when the puncture pattern is indicated by the notification from the gNB 200. The information may be information indicating whether transmission of the CSI-RS is required, a puncture ratio, and the like per time-frequency domain.
Information indicating a valid period: information indicating a valid period of the preference information, such as that the preference information is valid for one second. The UE 100 may adjust the valid period in accordance with the migration speed of the UE 100 itself or the like, for example, in such a manner that the valid period is short at the time of high-speed migration and is long at the time of low-speed migration or fixation.

The gNB 200 decides the partial CSI-RS transmission pattern (such as puncture) based on the preference information from the UE 100.

In step S406, the gNB 200 notifies the UE 100 of (configures for the UE 100) the decided partial CSI-RS transmission pattern as the control data. The notification (configuration) may be included in a switching notification providing notification of (indicating) switching to the inference mode.

In step S407, the UE 100 may transition from the learning mode to the inference mode.

In step S408, the gNB 200 transmits the CSI-RS to the UE 100 by using the decided partial CSI-RS transmission pattern.

### (2) Second Embodiment

A second embodiment is described mainly on differences from the first embodiment.

The first embodiment mainly describes the downlink reference signal (that is, downlink CSI estimation). The second embodiment describes an uplink reference signal (that is, uplink CSI estimation). In the description of the second embodiment, assume that the uplink reference signal is a sounding reference signal (SRS), but may be an uplink DMRS or the like.

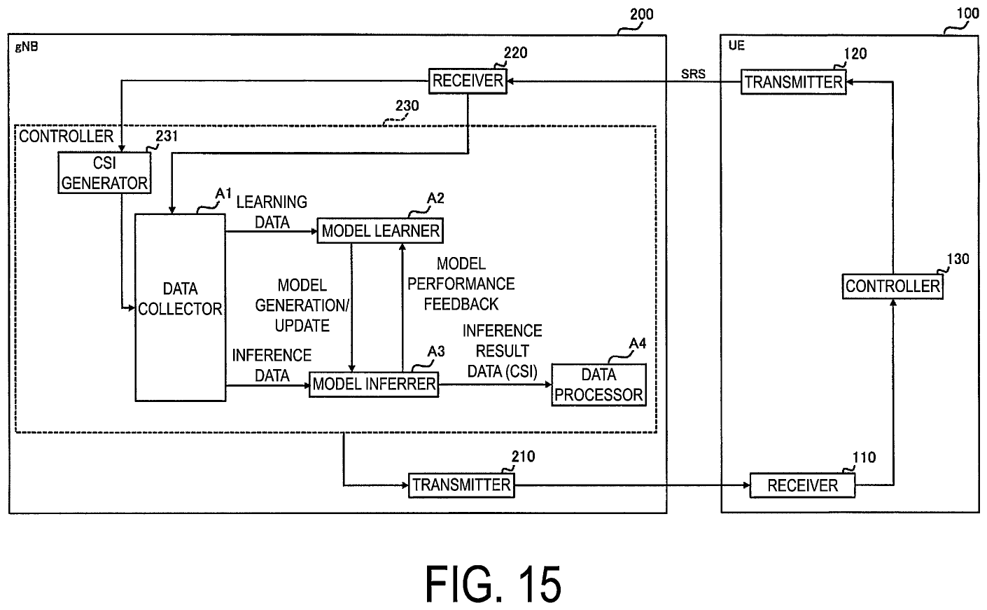

FIG. 15 is a diagram illustrating an operation scenario according to the second embodiment.

In the operation scenario according to the second embodiment, the data collector A1, the model learner A2, the model inferrer A3, and the data processor A4 are arranged in the gNB 200 (e.g., the controller 230). In other words, the model learning and the model inference are performed on the gNB 200 side.

In the second embodiment, the machine learning technology is introduced into the CSI estimation performed by the gNB 200 based on the SRS from the UE 100. Therefore, the gNB 200 (e.g., the controller 230) includes a CSI generator 231 that generates CSI based on the SRS received by the receiver 220 from the UE 100. The CSI is information indicating an uplink channel state between the UE 100 and the gNB 200. The gNB 200 (e.g., the data processor A4) performs, for example, uplink scheduling based on the CSI generated based on the SRS.

First, in the model learning, the gNB 200 (receiver 220) receives a first reference signal from the UE 100 by using a first resource. Then, the gNB 200 (model learner A2) derives a learned model for inferring CSI from the reference signal (SRS) by using learning data including the first reference signal. In the description of the second embodiment, such a first reference signal may be referred to as a full SRS.

For example, the gNB 200 (CSI generator 231) performs channel estimation by using the reception signal (SRS) received by the receiver 220 from the UE 100, and generates CSI. The model learner A2 performs model learning by using a plurality of sets of the reception signal (SRS) and the CSI as the learning data to derive a learned model for inferring the CSI from the reception signal (SRS).

Second, in the model inference, the gNB 200 (receiver 220) receives a second reference signal from the gNB 200 by using a second resource that is less than the first resource. Then, the UE 100 (model inferrer A3) uses the learned model to infer the CSI as the inference result data from inference data including the second reference signal. In the description of the second embodiment, such a second reference signal may be referred to as a partial SRS or a punctured SRS. For a puncture pattern of the SRS, the pattern the same as and/or similar to that in the first embodiment can be used (see FIGS. 9 and 10).

For example, the UE 100 (model inferrer A3) uses the reception signal (SRS) received by the receiver 220 from the gNB 200 as the inference data, and infers the CSI from the reception signal (SRS) by using the learned model.

This enables the gNB 200 to generate accurate (complete) CSI from a small number of SRSs (partial SRSs) received from the UE 100. For example, the UE 100 may reduce (puncture) the SRS when intended for overhead reduction. In addition, the gNB 200 can cope with a situation in which a radio situation deteriorates and some SRSs cannot be normally received.

In such an operation scenario, “CSI-RS”, “gNB 200”, and “UE 100” in the operation of the first embodiment described above can be read as “SRS”, “UE 100”, and “gNB 200”, respectively.

In the second embodiment, the gNB 200 transmits reference signal type information as the control data to the UE 100, the reference signal type information indicating a type of either the first reference signal (full SRS) or the second reference signal (partial SRS) to be transmitted by the UE 100. The UE 100 receives the reference signal type information and transmits the SRS designated by the gNB 200 to the gNB 200. This can cause the UE 100 to transmit an appropriated SRS.

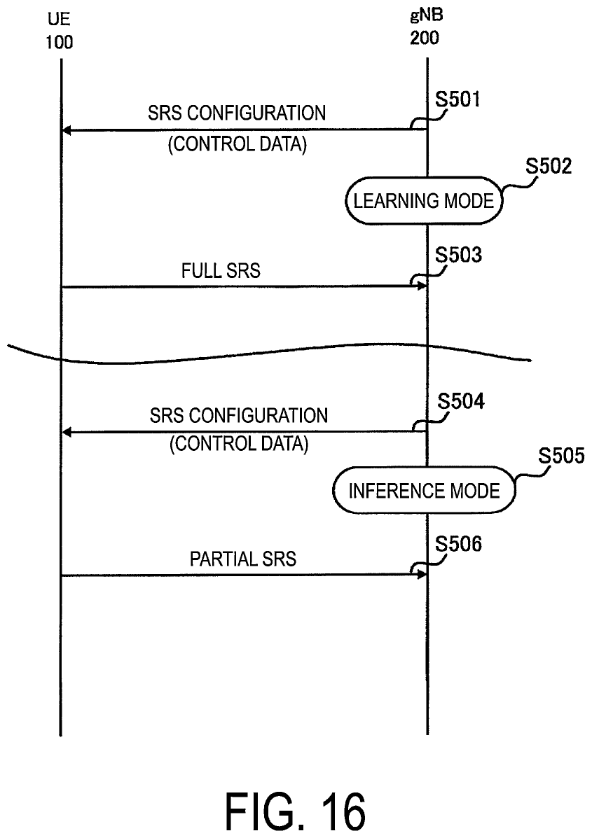

FIG. 16 is an operation flow diagram illustrating an operation example according to the second embodiment.

In step S501, the gNB 200 performs SRS transmission configuration for the UE 100.

In step S502, the gNB 200 starts the learning mode.

In step S503, the UE 100 transmits the full SRS to the gNB 200 in accordance with the configuration in step S501. The gNB 200 receives the full SRS and performs model learning for channel estimation.

In step S504, the gNB 200 specifies the transmission pattern (puncture pattern) of the SRS to be input as the inference data to the learned model, and configures the specified SRS transmission pattern for the UE 100.

In step S505, the gNB 200 transitions to the inference mode and starts the model inference using the learned model.

In step S506, the UE 100 transmits the partial SRS in accordance with the SRS transmission configuration in step S504. When the gNB 200 inputs the SRS as the inference data to the learned model to obtain a channel estimation result, the gNB 200 performs uplink scheduling (e.g., control of uplink transmission weight and the like) of the UE 100 by using the channel estimation result. Note that when the inference accuracy by way of the learned model deteriorates, the gNB 200 may reconfigure so that the UE 100 transmits the full SRS.

### (3) Third Embodiment

A third embodiment is described mainly on differences from the first and second embodiments.

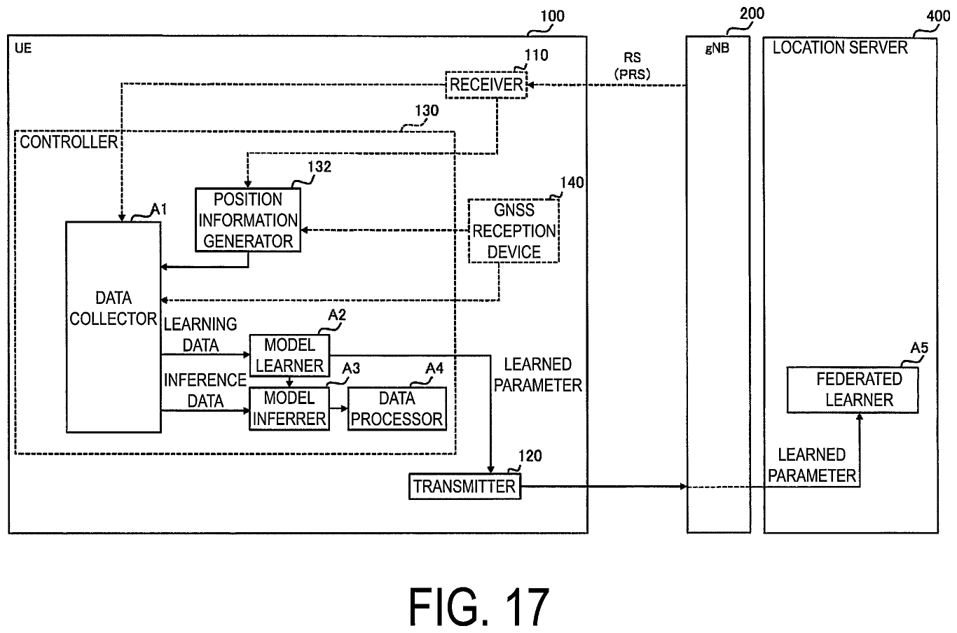

The third embodiment is an embodiment in which position estimation of the UE 100 (so-called UE positioning) is performed by using federated learning. FIG. 17 is a diagram illustrating an operation scenario according to the third embodiment. In an application example of such federated learning, the following procedure is performed.

First, a location server 400 transmits a model to the UE 100.

Second, the UE 100 performs model learning on the UE 100 (model learner A2) side using the date in the UE 100. The data in the UE 100 may be, for example, a positioning reference signal (PRS) received by the UE 100 from the gNB 200 and/or output data from the GNSS reception device 140. The information in the UE 100 may include position information (including latitude and longitude) generated by the position information generator 132 based on the reception result of the PRS and/or the output data from the GNSS reception device 140.

Third, the UE 100 applies the learned model, that is the learning result, to the UE 100 (model inferrer A3) and transmits variable parameters included in the learned model (hereinafter also referred to as “learned parameters”) to the location server 400. In the above example, the optimized a (slope) and b (intercept) correspond to the learned parameters.

Fourth, the location server 400 (federated learner A5) collects the learned parameters from a plurality of UEs 100 and integrates these parameters. The location server 400 may transmit the learned model obtained by the integration to the UE 100. The location server 400 can estimate the position of the UE 100 based on the learned model obtained by the integration and a measurement report from the UE 100.

In the third embodiment, the gNB 200 transmits trigger configuration information as the control data to the UE 100, the trigger configuration information configuring a transmission trigger condition for the UE 100 to transmit the learned parameters. The UE 100 receives the trigger configuration information and transmits the learned parameters to the gNB 200 (location server 400) when the configured transmission trigger condition is satisfied. This enables the UE 100 to transmit the learned parameters at an appropriate timing.

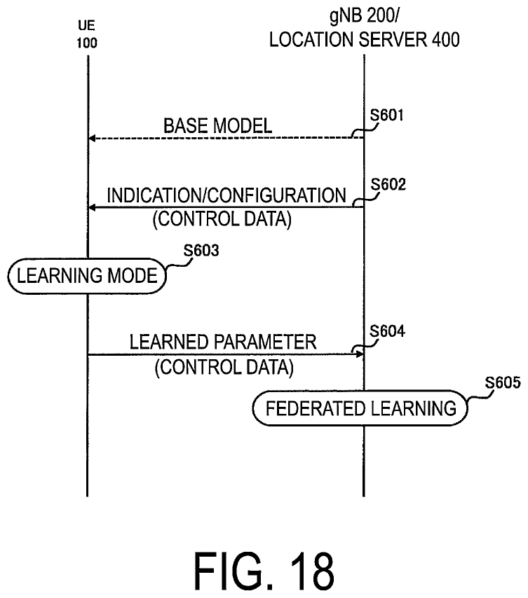

FIG. 18 is an operation flow diagram illustrating an operation example according to the third embodiment.

In step S601, the gNB 200 may transmit a notification indicating a base model that the UE 100 learns. Here, the base model may be a model learned in the past. As described above, the gNB 200 may transmit the data type information indicating what is to be input data to the UE 100.

In step S602, the gNB 200 indicates the model learning to the UE 100 and configures a report timing (trigger condition) of the learned parameter. The configured report timing may be a periodic timing. The report timing may be a timing triggered by learning proficiency satisfying a condition (that is, an event trigger).

For the periodic timing, the gNB 200 sets, for example, a timer value in the UE 100. The UE 100 starts a timer when starting learning (step S603) and reports the learned parameters to the gNB 200 (location server 400) when the timer expires (step S604). Alternatively, the gNB 200 may designate a radio frame or time to be reported to the UE 100. The radio frame may be designated as an absolute value, e.g., SFN=512. The radio frame may be calculated by using a modulo operation. For example, the gNB 200 reports the learned parameters at the SFN that “SFN mod N=0” holds for the UE 100, where N is a set value (step S604).

For the event trigger, the completion condition as described above is configured for the UE 100. The UE 100 reports the learned parameters to the gNB 200 (location server 400) when the completion condition is satisfied (step S604). The UE 100 may trigger the reporting of the learned parameters, for example, when the accuracy of the model inference is better than the previously transmitted model. Here, an offset may be introduced to trigger when “current accuracy>previous accuracy+offset” holds. The UE 100 may trigger the reporting of the learned parameters, for example, when the learning data is input (learned) N times or more. Such an offset and/or a value of N may be configured by the gNB 200 for the UE 100.

In step S604, when the condition of the report timing is satisfied, the UE 100 reports the learned parameters at that time to the network (gNB 200).

In step S605, the network (location server 400) integrates the learned parameters reported from a plurality of UEs 100.

### (4) Other Embodiments

The embodiments above describe the wireless communication between the UE 100 and the gNB 200, but the arrangements and operations described in the above embodiments may be applied to wireless communication (sidelink) between the UEs 100. For the sidelink, a first UE as the first communication apparatus performs wireless communication with a second UE as the second communication apparatus. The first UE transmits or receives the control data related to the model learning to and from the second UE.

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps may not be necessarily performed, and only some of the steps may be performed.

In the embodiment described above, an example in which the base station is an NR base station (i.e., a gNB) is described; however, the base station may be an LTE base station (i.e., an eNB). The base station may be a relay node such as an Integrated Access and Backhaul (IAB) node. The base station may be a Distributed Unit (DU) of the IAB node.

A program causing a computer to execute each of the processing performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM. Circuits for executing processing performed by the UE 100 or the gNB 200 may be integrated, and at least a part of the UE 100 or the gNB 200 may be implemented as a semiconductor integrated circuit (chipset, system on a chip (SoC)).

The phrases “based on” and “depending on” used in the present disclosure do not mean “based only on” and “only depending on,” unless specifically stated otherwise. The phrase “based on” means both “based only on” and “based at least in part on”. The phrase “depending on” means both “only depending on” and “at least partially depending on”. The terms “include”, “comprise” and variations thereof do not mean “include only items stated” but instead mean “may include only items stated” or “may include not only the items stated but also other items.” The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when English articles such as “a,” “an,” and “the” are added in the present disclosure through translation, these articles include the plural unless clearly indicated otherwise in context.

Embodiments have been described above in detail with reference to the drawings, but specific configurations are not limited to those described above, and various design variations can be made without departing from the gist of the present disclosure.

### Supplementary Note

Features relating to the embodiments described above are described below as supplements.

(1)

A communication control method performed by a first communication apparatus configured to perform wireless communication with a second communication apparatus in a mobile communication system using a machine learning technology, the communication control method including:
learning by performing model learning through which a learned model is derived by using learning data including a reception signal from the second communication apparatus; and
controlling transmission and/or reception of control data related to the model learning to and from the second communication apparatus.
   (2)

The communication control method according to (1) above, wherein
the reception signal includes a reference signal received by the first communication apparatus from the second communication apparatus.
   (3)

The communication control method according to (1) or (2) above, further including:
inferring by performing model inference through which inference result data is inferred from inference data including the reception signal from the second communication apparatus using the learned model.
   (4)

The communication control method according to any one of (1) to (3), wherein
the learning includes
receiving a first reference signal from the second communication apparatus by using a first resource, and
deriving the learned model for inferring channel state information from a reference signal by using the learning data including the first reference signal, and
the inferring includes
receiving a second reference signal from the second communication apparatus by using a second resource less than the first resource, and
inferring the channel state information as the inference result data from the inference data including the second reference signal, by using the learned model.
   (5)

The communication control method according to any one of (1) to (4) above, wherein
the first communication apparatus is a user equipment, and
the second communication apparatus is a base station.
   (6)

The communication control method according to any one of (1) to (5) above, wherein
the controlling includes receiving, by the user equipment from the base station, a switching notification as the control data, the switching notification providing notification of mode switching between a mode for performing the model learning and a mode for performing the model inference.
   (7)

The communication control method according to any one of (1) to (6) above, wherein
the controlling includes transmitting, by the user equipment to the base station, a completion notification as the control data when the model learning is completed, the completion notification indicating that the model learning is completed.
   (8)

The communication control method according to any one of (1) to (7) above, wherein
the controlling includes receiving, by the user equipment from the base station, a completion condition notification as the control data, the completion condition notification indicating a completion condition of the model learning.
   (9)

The communication control method according to any one of (1) to (8), wherein
the controlling includes receiving, by the user equipment from the base station, data type information as the control data, the data type information designating at least a type of data used as the learning data.
   (10)

The communication control method according to any one of (1) to (9) above, wherein
the controlling includes transmitting, by the user equipment to the base station, preference information as the control data, the preference information indicating a preference of the first communication apparatus for a transmission pattern of the second reference signal.
   (11)

The communication control method according to any one of (1) to (10) above, wherein
the first communication apparatus is a base station, and
the second communication apparatus is a user equipment.
   (12)

The communication control method according to any one of (1) to (11) above, wherein
the controlling includes transmitting, by the base station to the user equipment, reference signal type information as the control data, the reference signal type information indicating a type of a reference signal, out of the first reference signal and the second reference signal, to be transmitted by the user equipment.
   (13)

The communication control method according to any one of (1) to (12) above, wherein
the controlling includes transmitting, as the control data, a variable parameter included in the learned model to the second communication apparatus,
the first communication apparatus is a user equipment, and
the second communication apparatus is a base station.
   (14)

The communication control method according to any one of (1) to (13) above, wherein
the controlling further includes receiving, by the user equipment from the base station, trigger configuration information as the control data, the trigger configuration information being for configuring a transmission trigger condition for the user equipment to transmit the variable parameter.
   (15)

A communication apparatus for communicating with another communication apparatus in a mobile communication system using a machine learning technology, the communication apparatus including:
a controller configured to perform
processing of performing model learning through which a learned model is derived using learning data including a reception signal from the other communication apparatus, and
processing of transmitting and/or receiving control data related to the model learning to and from the other communication apparatus.

### REFERENCE SIGNS

1: Mobile communication system
100: UE
110: Receiver
120: Transmitter
130: Controller
131: CSI generator
132: Position information generator
140: GNSS reception device
200: gNB
210: Transmitter
220: Receiver
230: Controller
231: CSI generator
240: Backhaul communicator
400: Location server
A1: Data collector
A2: Model learner
A3: Model inferrer
A4: Data processor
A5: Federated learner

1. A communication control method performed by a first communication apparatus configured to perform wireless communication with a second communication apparatus in a mobile communication system using a machine learning technology, the communication control method comprising:
learning by performing model learning through which a learned model is derived by using learning data comprising a reception signal from the second communication apparatus; and
controlling transmission and/or reception of control data related to the model learning to and from the second communication apparatus.

2. The communication control method according to claim 1, wherein
the reception signal comprises a reference signal received by the first communication apparatus from the second communication apparatus.

3. The communication control method according to claim 1, further comprising:
inferring by performing model inference through which inference result data is inferred from inference data comprising the reception signal from the second communication apparatus, by using the learned model.

4. The communication control method according to claim 3, wherein
the learning comprises
receiving a first reference signal from the second communication apparatus by using a first resource, and
deriving the learned model for inferring channel state information from a reference signal by using the learning data comprising the first reference signal, and
the inferring comprises
receiving a second reference signal from the second communication apparatus by using a second resource less than the first resource, and
inferring the channel state information as the inference result data from the inference data comprising the second reference signal, by using the learned model.

5. The communication control method according to claim 4, wherein
the first communication apparatus is a user equipment, and
the second communication apparatus is a base station.

6. The communication control method according to claim 5, wherein
the controlling comprises receiving, by the user equipment from the base station, a switching notification as the control data, the switching notification providing notification of mode switching between a mode for performing the model learning and a mode for performing the model inference.

7. The communication control method according to claim 5, wherein
the controlling comprises transmitting, by the user equipment to the base station, a completion notification as the control data when the model learning is completed, the completion notification indicating that the model learning is completed.

8. The communication control method according to claim 5, wherein
the controlling comprises receiving, by the user equipment from the base station, a completion condition notification as the control data, the completion condition notification indicating a completion condition of the model learning.

9. The communication control method according to claim 5, wherein
the controlling comprises receiving, by the user equipment from the base station, data type information as the control data, the data type information designating at least a type of data used as the learning data.

10. The communication control method according to claim 5, wherein
the controlling comprises transmitting, by the user equipment to the base station, preference information as the control data, the preference information indicating a preference of the first communication apparatus for a transmission pattern of the second reference signal.

11. The communication control method according to claim 4, wherein
the first communication apparatus is a base station, and
the second communication apparatus is a user equipment.

12. The communication control method according to claim 5, wherein
the controlling comprises transmitting, by the base station to the user equipment, reference signal type information as the control data, the reference signal type information indicating a type of a reference signal, out of the first reference signal and the second reference signal, to be transmitted by the user equipment.

13. The communication control method according to claim 1, wherein
the controlling comprises transmitting, as the control data, a variable parameter comprised in the learned model to the second communication apparatus,
the first communication apparatus is a user equipment, and
the second communication apparatus is a base station.

14. The communication control method according to claim 13, wherein
the controlling further comprises receiving, by the user equipment from the base station, trigger configuration information as the control data, the trigger configuration information being for configuring a transmission trigger condition for the user equipment to transmit the variable parameter.

15. A communication apparatus for communicating with another communication apparatus in a mobile communication system using a machine learning technology, the communication apparatus comprising:
a controller configured to perform
processing of performing model learning through which a learned model is derived by using learning data comprising a reception signal from the other communication apparatus, and
processing of transmitting and/or receiving control data related to the model learning to and from the other communication apparatus.
